(19) United States
(12) Patent Application Publication
(10) Pub. No.: US 2025/0309709 A1
(43) Pub. Date: Oct. 2, 2025

(54) ROTOR FOR ROTATING ELECTRICAL MACHINE

(71) Applicant: HONDA MOTOR CO., LTD., Tokyo (JP)

(72) Inventors: Takumi TODOROKI, Saitama (JP); Yoshihisa KUBOTA, Saitama (JP)

(21) Appl. No.: 19/054,919

(22) Filed: Feb. 17, 2025

(30) Foreign Application Priority Data
Mar. 26, 2024 (CN) 202410349961.7

(51) Int. Cl. H02K 1/276; H02K 29/03

(52) U.S. Cl. CPC H02K 1/276; H02K 29/03

(57) ABSTRACT

The plurality of holes include two inner holes located on a radially inner side and one outer hole located on a radially outer side relative to the inner holes for each of the magnetic pole. The two inner holes include a first inner hole located on a rotating direction side of the rotor and a second inner hole located on a counter-rotating direction side relative to the first inner hole. When the central axis of the magnetic pole is defined as a d-axis and an axis shifted by 90° in electrical angle from the d-axis is defined as a q-axis, the first inner hole and the second inner hole are disposed facing each other with the d-axis at the center. The rotor core has a gap portion that is a recess formed at an outer peripheral portion of the rotor core and that communicates with the second inner hole.

This application is based on and claims the benefit of priority from Chinese Patent Application No. CN202410349961.7, filed on 26 Mar. 2024, the content of which is incorporated herein by reference.

### BACKGROUND OF THE INVENTION

### Field of the Invention

The present invention relates to a rotor for a rotating electrical machine, and, particularly, to a rotor for a rotating electrical machine capable of reducing torque ripple that is a periodic torque fluctuation occurring during rotation.

### Related Art

In recent years, initiatives to realize a low-carbon society or a carbon-free society have been active, and research and development on vehicle electrification have been conducted to reduce CO₂ emissions and improve energy efficiency. Here, in respect of a rotating electrical machine, it is a challenge to reduce torque ripple that is a periodic torque fluctuation occurring during rotation. Particularly, when the rotating electrical machine is configured as a two-phase motor, large torque ripple at an electrical angle of fourth order is likely to occur.

Japanese Patent No. 6435838 discloses a configuration in which holes in which permanent magnets are inserted and fixed are provided at equal intervals in a circumferential direction of a rotor for a rotating electrical machine, and a gap portion having a substantially semicircular shape when viewed in an axial direction is provided at a position near a radially outer side between adjacent holes.

Patent Document 1: Japanese Patent No. 6435838

### SUMMARY OF THE INVENTION

However, the gap portion disclosed in Japanese Patent No. 6435838 is provided for the purpose of enhancing the strength of a partition wall that defines the gap portion and the holes in which the permanent magnets are inserted and fixed and enabling high-speed rotation of the rotating electrical machine. Therefore, there has been a demand for, in particular, a rotor structure capable of reducing large fourth-order torque ripple that occurs when the rotating electrical machine is a two-phase motor.

In order to overcome the disadvantage described above, it is an object of the present application is to reduce torque ripple in a rotating electrical machine by improving the rotor structure. This will ultimately contribute to improving the energy efficiency.

In order to achieve the object, the present invention has a first characteristic in that a rotor for a rotating electrical machine includes a rotor core having an annular shape, the rotor core having a plurality of holes formed therein, the plurality of holes each being provided with a permanent magnet inserted and fixed therein to create a plurality of magnetic poles arranged at equal intervals in a circumferential direction. The plurality of holes include two inner holes located on a radially inner side and one outer hole located on a radially outer side relative to the inner holes for each of the magnetic poles, the two inner holes include a first inner hole located on a rotating direction side of the rotor and a second inner hole located on a counter-rotating direction side relative to the first inner hole, when the central axis of the magnetic pole is defined as a d-axis and an axis shifted by 90° in electrical angle from the d-axis is defined as a q-axis, the first inner hole and the second inner hole are disposed facing each other with the d-axis at a center, and the rotor core has a gap portion that is a recess formed at an outer peripheral portion of the rotor core and that communicates with the second inner hole.

Moreover, the present invention has a second characteristic in that the gap portion is located on a magnetic path of the q-axis located on the counter-rotating direction side of the rotor relative to the d-axis.

Further, the present invention has a third characteristic in that each of the first inner hole and the second inner hole has an elongated shape in which the permanent magnet having a rectangular shape when viewed in an axial direction is insertable and which has one end portion near the d-axis and the other end portion away from the d-axis relative to the one end portion, and the first inner hole and the second inner hole are inclined symmetrically to each other such that the other end portion is positioned on the radially outer side relative to the one end portion.

Furthermore, the present invention has a fourth characteristic in that a circumferential dimension of the gap portion increases toward the radially outer side.

Moreover, the present invention has a fifth characteristic in that the circumferential dimension of the gap portion near the radially outer side is greater than or equal to ¼ of the circumferential length of one magnetic pole of the rotor core, and a radial dimension of the gap portion is greater than or equal to 1/10 of the radius of the rotor core.

Further, the present invention has a sixth characteristic in that the first inner hole and the second inner hole are separated from each other by a partition wall extending in a radial direction, and the partition wall is inclined such that the radially outer side is located on the rotating direction side of the rotor relative to the radially inner side when viewed in the axial direction.

Furthermore, the present invention has a seventh characteristic in that the rotating electrical machine is a two-phase motor.

According to the first characteristic, the rotor for the rotating electrical machine includes a rotor core having an annular shape and a plurality of holes formed therein, the plurality of holes each being provided with a permanent magnet inserted and fixed therein to create a plurality of magnetic poles arranged at equal intervals in the circumferential direction, the plurality of holes include two inner holes located on the radially inner side and one outer hole located on the radially outer side relative to the inner holes for each of the magnetic poles, the two inner holes include a first inner hole located on the rotating direction side of the rotor and a second inner hole located on the counter-rotating direction side relative to the first inner hole, when the central axis of the magnetic pole is defined as the d-axis and an axis shifted by 90° in electrical angle from the d-axis is defined as the q-axis, the first inner hole and the second inner hole are disposed facing each other with the d-axis at the center, and the rotor core has a gap portion that is a recess formed at the outer peripheral portion of the rotor core and that communicates with the second inner hole. Thus, by providing the gap portion, torque that originates between the outer hole and the second inner hole and is directed to the radially outer side of the rotor core and the counter-rotating direction side is reduced, and the torque ripple of the rotating electrical machine can be reduced.

According to the second characteristic, the gap portion is located on the magnetic path of the q-axis located on the counter-rotating direction side of the rotor relative to the d-axis. Thus, by providing the gap portion on the magnetic path on the q-axis, torque caused by the magnetic path of the q-axis is reduced, and the torque ripple of the rotating electrical machine can be reduced.

According to the third characteristic, each of the first inner hole and the second inner hole has an elongated shape in which the permanent magnet having a rectangular shape when viewed in an axial direction is insertable and which has one end portion near the d-axis and an other end portion away from the d-axis relative to the one end portion, and the first inner hole and the second inner hole are inclined symmetrically to each other such that the other end portion is positioned on the radially outer side relative to the one end portion. Thus, the outer hole and the inner hole can be disposed close to each other, and the radial dimension of the rotor core can be reduced.

According to the fourth characteristic, since the circumferential dimension of the gap portion increases toward the radially outer side, it is possible to increase the circumferential dimension of the gap portion at a position near the radially outer side while ensuring the strength of the portion at which the second inner hole and the gap portion communicate with each other. Consequently, it is possible to further enhance the effect of reducing the torque ripple.

According to the fifth characteristic, the circumferential dimension of the gap portion near the radially outer side is greater than or equal to ¼ of the circumferential length of one magnetic pole of the rotor core, and the radial dimension of the gap portion is greater than or equal to 1/10 of the radius of the rotor core. Therefore, it is possible to effectively reduce the torque ripple in the rotating electrical machine.

According to the sixth characteristic, the first inner hole and the second inner hole are separated from each other by the partition wall extending in the radial direction, and the partition wall is inclined such that the radially outer side is located on the rotating direction side of the rotor relative to the radially inner side when viewed in the axial direction. Therefore, particularly, at an end portion of the first inner hole near the d-axis and an end portion of the second inner hole near the d-axis, when flux barriers are formed as spaces that are not occupied by the permanent magnets and do not allow magnetic flux to pass through, the partition wall that separates the first inner hole and the second inner hole tends to be thin. Further, it is considered that providing the gap portion may cause a bias in the distribution of centrifugal force and a concentration of torsional stress on the partition wall. Therefore, by forming the partition wall along the direction of centrifugal force, it is possible to reduce the influence of torsional stress.

According to the seventh characteristic, the rotating electrical machine is a two-phase motor. When the rotating electrical machine is a two-phase motor, a magnetic flux overlap in space is small, a spatial fourth-order harmonic is generated, and large torque ripple at an electrical angle of fourth order is likely to occur, but the fourth-order torque ripple can be effectively reduced.

### BRIEF DESCRIPTION OF THE DRAWINGS

FIG. 1 is a front view (axial view) of a rotating electrical machine;

FIG. 2 is a front view of a rotor forming part of the rotating electrical machine;

FIG. 3 is a front view of a rotor core constituting one magnetic pole, and a stator;

FIG. 4 is a front view of the rotor core constituting one magnetic pole; and

FIG. 5 is an enlarged view of the rotor core in the vicinity of a gap portion.

### DETAILED DESCRIPTION OF THE INVENTION

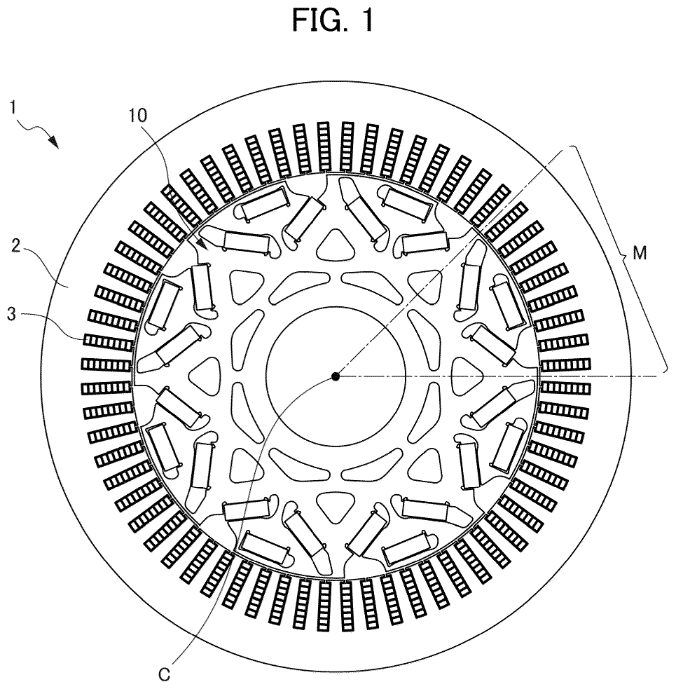

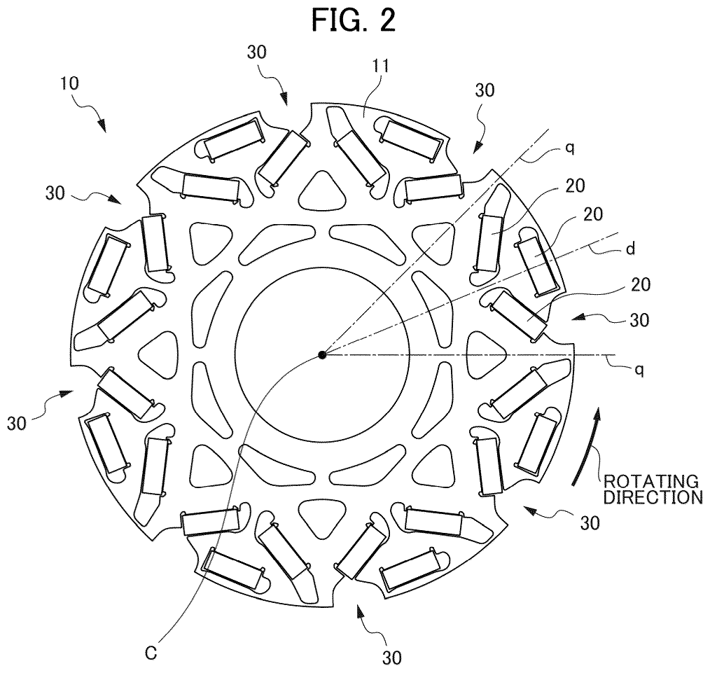

Hereinafter, a preferred embodiment of the present invention will be described in detail with reference to the drawings. FIG. 1 is a front view (axial view) of a rotating electrical machine 1 according to an embodiment of the present invention. FIG. 2 is a front view of a rotor 10 forming part of the rotating electrical machine 1. The rotating electrical machine 1 is an inner rotor type two-phase motor configured by housing the rotor 10 having a rotating shaft (not shown), at the inner periphery of an annular stator core 2 around which a plurality of stator coils 3 are wound.

A rotor core 11 constituting the rotor 10 is formed by stacking a large number of electromagnetic steel sheets punched into an annular shape. A plurality of permanent magnets 20 are inserted and fixed in predetermined positions in a plurality of holes formed in the rotor core 11. Consequently, eight magnetic poles M are formed in the present embodiment.

The central axis of the magnetic pole M passing through a rotation center C of the rotor core 11 constitutes a d-axis (d) as a field magnetic flux direction, and an axis that is shifted by 90° electrical angle from the d-axis constitutes a q-axis (q) as an armature magnetic flux direction. In the rotating electrical machine 1 according to the present embodiment, the counterclockwise direction shown in the drawing is the main rotating direction of the rotor 10. The rotor core 11 according to the present embodiment is characterized in that a gap portion 30 is formed as a recess formed at an outer peripheral portion of the rotor core 11, at a position between the d-axis and the q-axis located on the counter-rotating direction side (the clockwise direction side in the drawing) of the d-axis.

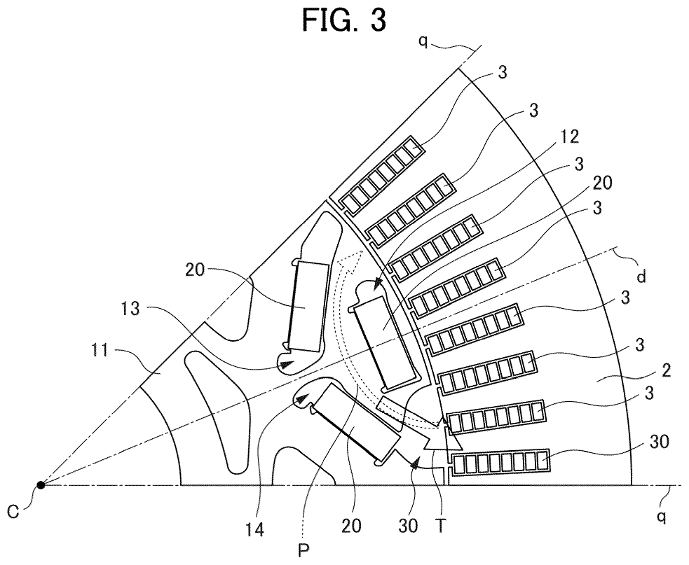

FIG. 3 is a front view of the rotor core 11 constituting one magnetic pole M, and a stator 2. The same reference numerals as those described above indicate the same or equivalent parts. In the rotor core 11, a plurality of holes are formed to insert and fix a permanent magnet 20 having a rectangular shape when viewed in the axial direction. The holes include two inner holes 13, 14 located on the radially inner side, and one outer hole 12 located on the radially outer side relative to the inner holes 13, 14. The d-axis is an axis passing through the rotation center C of the rotor core 11 and the center of the permanent magnet 20 inserted and fixed in the outer hole 12.

Meanwhile, the inner holes 13, 14 include the first inner hole 13 located on the rotating direction side of the d-axis and the second inner hole 14 located on the counter-rotating direction side of the d-axis, and are disposed facing each other with the d-axis at the center. More specifically, each of the first inner hole 13 and the second inner hole 14 has an elongated shape in which the permanent magnet 20 having a rectangular shape when viewed in the axial direction is insertable and which has one end portion near the d-axis and the other end portion away from the d-axis relative to the one end portion, and the first inner hole 13 and the second inner hole 14 are disposed symmetrically with each other in an inclined manner such that the other end portion is positioned on the radially outer side relative to the one end portion. Consequently, the outer hole 12 and the inner holes 13, 14 can be disposed close to each other, thereby allowing a reduction in the radial dimension of the rotor core 11.

Here, when the rotating electrical machine 1 is a two-phase motor, a magnetic flux overlap in space is small, a spatial fourth-order harmonic is generated, and large torque ripple at an electrical angle of fourth order is likely to occur. This is due to torque T (shown by the black arrow in the drawing) that originates between the outer hole 12 and the second inner hole 14 and is directed to the radially outer side and the counter-rotating direction side. Therefore, in the present embodiment, by providing the gap portion 30 that is the recess formed at the outer peripheral portion of the rotor core 11 and that communicates with the second inner hole 14, the torque T is reduced, and the fourth-order torque ripple of the rotating electrical machine 1 can be reduced.

The gap portion 30 is located on a magnetic path P (indicated by a broken line arrow in the drawing) of the q-axis located on the counter-rotating direction side of the rotor 10 relative to the d-axis. Consequently, the torque T caused by the magnetic path P of the q-axis is reduced, and the torque ripple in the rotating electrical machine 1 can be reduced.

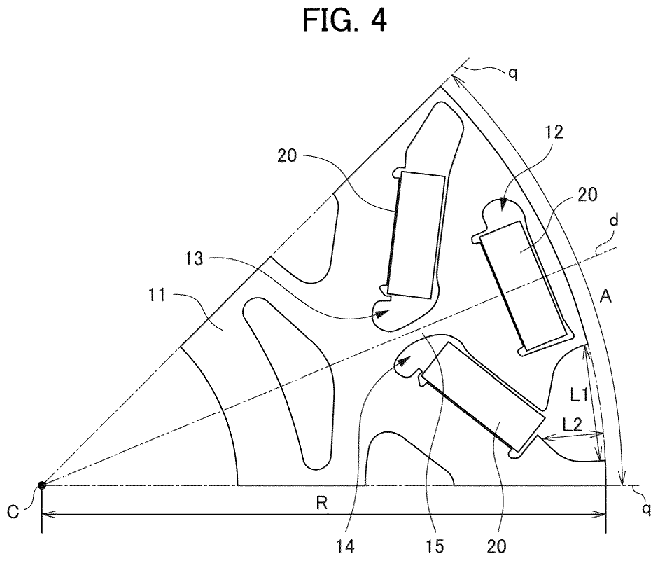

FIG. 4 is a front view of the rotor core 11 corresponding to one magnetic pole M. The gap portion 30 according to the present embodiment has a shape in which the circumferential dimension increases toward the radially outer side. Consequently, the circumferential dimension of the gap portion 30 is increased at a position near the radially outer side while ensuring the strength of the portion at which the second inner hole 14 and the gap portion 30 communicate with each other, and the effect of reducing the torque ripple is further enhanced.

Moreover, a circumferential dimension L1 of the gap portion 30 near the radially outer side is greater than or equal to ¼ of a circumferential length A of one magnetic pole M, and a radial dimension L2 of the gap portion 30 is greater than or equal to 1/10 of a radius R of the rotor core 11. Consequently, it is possible to more effectively reduce the torque ripple in the rotating electrical machine 1. The first inner hole 13 and the second inner hole 14 are separated from each other by a partition wall 15 located on the d-axis.

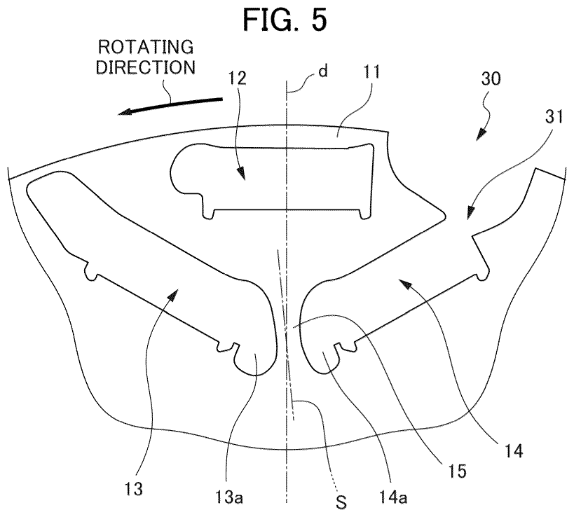

FIG. 5 is an enlarged view of the rotor core 11 in the vicinity of the gap portion 30. As described above, the gap portion 30 has the shape in which the circumferential dimension increases toward the radially outer side, and communicates with the end portion of the second inner hole 14 on the side further away from the d-axis through a communication portion 31. According to experiments, it has been known that the effect of reducing the torque ripple decreases when the size as a whole is small or the opening area on the outer peripheral side of the rotor core 11 is small relative to the gap portion 30 of the present embodiment.

Moreover, at the end portion of the first inner hole 13 near the d-axis and the end portion of the second inner hole 14 near the d-axis, flux barriers 13a, 14a are formed as spaces that are not occupied by the permanent magnets 20 and do not allow magnetic flux to pass through, and the partition wall 15 that separates the first inner hole 13 and the second inner hole 14 tends to be thin. Further, it is considered that providing the gap portion 30 for reducing the torque ripple may cause a bias in the distribution of centrifugal force, and a concentration of torsional stress on the partition wall 15. Therefore, in the present embodiment, the partition wall 15 is inclined such that the radially outer side is located on the rotating direction side of the rotor 10 relative to the radially inner side when viewed in the axial direction. Consequently, since the partition wall 15 is formed along the centrifugal force direction, it is possible to reduce the influence of the torsional stress.

The form of the rotating electrical machine, the shapes and structures of the stator and the rotor, the shape of the rotor core, the number of lightening holes, the number of magnetic poles, the shape and number of the permanent magnets, the shape and number of the respective holes, the shape and dimensions of the gap portion, the shape of the partition wall, etc. are not limited to the above embodiment, and can be modified in various ways. The above embodiment shows the structure when the main rotating direction of the rotor is the counterclockwise direction when viewed in the axial direction of the rotating electrical machine, however, when the main rotating direction of the rotor is the clockwise direction, the same torque ripple reduction effect as in the above embodiment can be obtained by providing the gap portion at a position on the opposite side of the d-axis. The rotor structure of the rotating electrical machine according to the present invention can be applied to a three-phase motor and a five-phase motor, without being limited to a two-phase motor.

### EXPLANATION OF REFERENCE NUMERALS

1 rotating electrical machine, 10 rotor, 11 rotor core, 12 outer hole, 13 first inner hole (hole), 14, second inner hole (hole), 15 partition wall, 20 permanent magnet, 30 gap portion, M magnetic pole, d d-axis, q q-axis, P magnetic path of q-axis, A circumferential length of one magnetic pole, R radius of rotor core, L1 circumferential dimension of gap portion near radially outer side, and L2 radial dimension of gap portion.

What is claimed is:

1. A rotor for a rotating electrical machine, the rotor comprising a rotor core having an annular shape,
the rotor core having a plurality of holes formed therein, the plurality of holes each being provided with a permanent magnet inserted and fixed therein to create a plurality of magnetic poles arranged at equal intervals in a circumferential direction, wherein
the plurality of holes include two inner holes located on a radially inner side and one outer hole located on a radially outer side relative to the inner holes for each of the magnetic poles,
the two inner holes include a first inner hole located on a rotating direction side of the rotor and a second inner hole located on a counter-rotating direction side relative to the first inner hole,
when a central axis of the magnetic pole is defined as a d-axis and an axis shifted by 90° in electrical angle from the d-axis is defined as a q-axis, the first inner hole and the second inner hole are disposed facing each other with the d-axis at a center, and
the rotor core has a gap portion that is a recess formed at an outer peripheral portion of the rotor core and that communicates with the second inner hole.

2. The rotor for the rotating electrical machine according to claim 1, wherein
the gap portion is located on a magnetic path of the q-axis located on the counter-rotating direction side of the rotor relative to the d-axis.

3. The rotor for the rotating electrical machine according to claim 1, wherein
each of the first inner hole and the second inner hole has an elongated shape in which the permanent magnet having a rectangular shape when viewed in an axial direction is insertable and which has one end portion near the d-axis and an other end portion away from the d-axis relative to the one end portion, and
the first inner hole and the second inner hole are inclined symmetrically to each other such that the other end portion is positioned on the radially outer side relative to the one end portion.

4. The rotor for the rotating electrical machine according to claim 1, wherein
a circumferential dimension of the gap portion increases toward the radially outer side.

5. The rotor for the rotating electrical machine according to claim 4, wherein
the circumferential dimension of the gap portion near the radially outer side is greater than or equal to ¼ of a circumferential length of one magnetic pole of the rotor core, and
a radial dimension of the gap portion is greater than or equal to 1/10 of a radius of the rotor core.

6. The rotor for the rotating electrical machine according to claim 3, wherein
the first inner hole and the second inner hole are separated from each other by a partition wall extending in a radial direction, and
the partition wall is inclined such that the radially outer side is located on the rotating direction side of the rotor relative to the radially inner side when viewed in the axial direction.

7. The rotor for the rotating electrical machine according to claim 1, wherein
the rotating electrical machine is a two-phase motor.
